(19) United States
(12) Patent Application Publication
(10) Pub. No.: US 2008/0200328 A1
(43) Pub. Date: Aug. 21, 2008

(54) Method and Device For Applying Washcoat Suspensions to a Molded Article

(76) Inventors: Hans-Jurgen Eberle, Munchen (DE); Olaf Helmer, Munchen (DE); Jorg Spengler, Planegg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/915,368

(22) PCT Filed: May 24, 2006
(86) PCT No.: PCT/EP2006/005001

§ 371 Date: Nov. 23, 2007

(30) Foreign Application Priority Data
May 25, 2005 (DE) 10 2005 024 124.7

(51) Int. Cl. B28B 1/26; B01J 23/00

(52) U.S. Cl. 502/100; 427/238; 425/405.1

(57) ABSTRACT

The invention relates to a method for removing an excess of a liquid from a molded article that comprises two opposite planar faces and interior cavities and/or channels to be coated with the liquid. The inventive method is characterized by removing in a first removal step, once the liquid has been introduced into the interior cavities and/or channels, the major portion of the excess liquid under the influence of an external force, and removing in a second removal step the excess liquid remaining in the molded article after the first removal step by contacting the molded article with a porous and/or channel-bearing support on the very face where the excess was removed. The pore and/or channel diameter of the support is smaller or equal the diameter of the interior cavities and/or channels of the molded article.

The invention relates to a method and a device for the production of carrier-borne catalysts by the application of a washcoat suspension to a molded article having ducts or pores, as a carrier, and to the use of the carrier-borne catalysts thus obtained in the purification of exhaust gases, in particular exhaust gases from internal combustion engines.

Catalysts based on coated molded articles, for example what are known as monoliths, or metal foams for the purification of exhaust gases, such as the oxidation of CO or hydrocarbons into CO₂ and water or the reduction of NOₓ with ammonia or urea into N₂ and water or the decomposition of urea or its thermal decomposition product, isocyanic acid, into ammonia and CO₂, have been known for a long time.

As a rule, these catalysts are constructed in that a monolithic carrier material (“honeycomb” in the case of ducts or ceramic or metal foam in the case of pores) , pierced with ducts or pores, is covered with a (high-surface) metal oxide coating (washcoat) having a large surface and consisting, for example, of Al₂O₃, SiO₂ or TiO₂ or their mixed oxides, and the actually catalytically active metals or metal compounds, such as, for example, noble metals or transition metal oxides, and, if appropriate, additional promoter compounds/dopants are applied to these metal-oxidic surfaces. There are also applications, however, in which the metal oxide coatings alone are catalytically active. A typical example of use in this respect is the hydrolysis of isocyanic acid into ammonia on TiO₂-coated molded articles.

Monoliths, often also called “honeycombs”, consist, for example, of a honeycomb body which may be composed of a honeycomb casing and of a carrier, for example a partially structured and wound-up sheet metal foil, which is inserted in it. Another possibility is, for example, that the honeycomb consists overall of a purely ceramic molded article. The honeycomb is in this case pierced essentially by ducts running parallel to the main axis of the honeycomb.

Metal or ceramic foams are highly porous molded articles which may assume any desired geometric shapes.

In both instances mentioned above, cylindrical shapes are mostly preferred.

The ducts piercing a monolithic carrier (honeycomb) may in this case possess an ordered or unordered duct structure, furthermore the ducts running essentially parallel may also be connected to one another (what are known as open duct structures), for example also by means of porous duct walls. In the case of open duct structures, radial gas distribution within the honey-comb body also becomes possible. The size of the honeycombs and also the dimensioning of the ducts are in this case determined predominantly by the dimension of the exhaust gas line systems, the required pressure losses and the required dwell times of the exhaust gas. The same applies accordingly to the corresponding highly porous metallic and ceramic sponge or foam structures.

The cell density, as it is known, to be precise the number of ducts or pores per molded article or surface of an end face of the molded article, likewise depends on requirements. As a rule, these lie between 50 and 1000 ducts/pores per inch² (=cells per square inch, cpsi). In individual instances or for special applications, these cell densities may be undershot downward or overshot upward. The higher this cell density of the molded article is, the higher is the surface available for reaction; in the same way, however, the pressure loss also increases with an increasing cell density.

Materials used for molded articles capable of being employed according to the invention are, for examples materials such as cordierite, steatite, duranite® or silicon carbide, or molded articles consisting of silicon dioxide, aluminum oxides, aluminates or else metals and metal alloys. The use of metals and metal alloys makes it possible, in particular, to produce complexly structured molded articles, such as, for example, honeycombs with open duct structures or ceramic or metal foams, the pore structure of which has a particularly high internal surface.

The production of a catalyst based on a molded article capable of being employed according to the invention takes place, as a rule, by the application of a wash-coat (WC) to the surface of its internal voids, that is to say, for example, its duct walls, pores, etc. (coating), followed by drying with subsequent calcination at higher temperatures for the consolidation and ultimate surface configuration of the washcoat. The catalytically active components are thereafter applied to the washcoat by means of impregnation steps, mostly from the aqueous solutions of their precursors. It is also possible, however, to apply the active components or their precursor compounds directly during the coating process.

The coating of a molded article (designated below for the sake of simplicity as “molded article”) having internal voids or ducts with the inorganic high-surface materials is possible by means of various methods. As a rule, first, a suspension of the inorganic carrier oxide in water is produced, if appropriate with the addition of additives, such as inorganic or organic binders, surfactants, catalytic active components, pore formers, rheology promoters and other admixtures. Subsequently, the molded article is filled with this washcoat suspension, as it is known, by means of an immersion, suction or pumping process.

In the prior art, methods are described in which only the exactly calculated quantity of washcoat suspension to remain in the molded article is introduced into the molded article, and this quantity is distributed as uniformly as possible to the duct walls or pore walls.

Other methods introduce an excess into the molded article (for example the flooding of the molded article) and carry out a subsequent emptying operation, by means of which excess washcoat suspension is discharged. Blow-out by means of an air stream is often carried out for emptying purposes.

DE 19837731 A1 discloses several of these method variants. The emptying of the excess washcoat from a honeycomb body by means of a centrifuge unit is described, for example, in GB 1504060.

The currently enhanced statutory requirements as regards the purification of exhaust gases, in particular engine exhaust gases, necessitate the development of novel catalysts with markedly higher effectiveness. In addition to the improvement in the catalytic coating the efficiency of catalysts can also be increased markedly by means of optimized carrier materials.

For this purpose, on the one hand, the cell density may be increased, but complexly structured molded articles, as they are known, may also be used. Where honeycomb bodies are concerned, complexly structured honeycomb bodies are understood to mean honeycombs in which the ducts have elevations or depressions or blades. As a result, turbulences are generated in a directed manner in the gas stream passing through the molded article and likewise lead to better substance transport and consequently higher activities. Open structures also belong to this type of carrier. In the case of open structures, as already described above, the ducts are connected to one another by means of corresponding perforations (holes, pores) As a result, in addition to a vertical flow direction (parallel to the duct axis), a more or less horizontal gas flow (radial with respect to the axis of the honeycomb or the ducts) is also possible. By means of complex structures, catalysts can be produced which at the same time bring about a mixing effect. Furthermore, combinations of purely plane-parallel and complexly structured honeycombs may, of course, also be envisaged. Metal foams are per se complexly structured, but can be produced more simply.

Honeycombs or porous molded articles with high cell densities and also honeycombs with complexly structured and perforated ducts (open structures) cannot be coated by means of the methods known hitherto without an undesirably high outlay. In particular, with open duct structures or pore structures, it is no longer possible to blow out the excess washcoat suspension by means of air.

The reason for this is that the air (blow-out air) used for blowing out follows basically the path of least resistance (path of least pressure loss) . As soon as individual open ducts or pore structures have occurred between the two end faces of the molded article, the blow-out air subsequently used is discharged through the holes of the open structures precisely into those ducts or pore structures which are already open, and the pressure of the blow-out air employed is not sufficient to blow out downward the washcoat suspension from still partly filled ducts or pores in which the washcoat suspension is held by capillary forces. Even only a few ducts or pore structures emptied completely by blowing out lead to the effect described, so that only a few ducts can be emptied by blowing out alone.

This effect, to be observed particularly in honeycombs with open structures or porous ceramic and metal foams, is illustrated in FIG. 1.

FIG. 1 shows a part view of two parallel-running ducts of a honeycomb which are connected to one another via a perforation (open structure) Whereas the duct shown on the right has already been freed of excess washcoat by the blow-out air (the flow direction of the air is illustrated by the arrows), this is no longer possible in the duct shown on the left for the reason described above, so that a washcoat residue which can no longer be removed by blowing out alone and is held by the capillary force remains in the lower region of the duct. The same applies, for example, to cylindrical metal foam molded articles.

Ever more complicated methods are therefore necessary for the coating of complexly structured molded articles, in particular of honeycombs and foams. Thus, DE 10114328 A1 describes the use of vibrations in the application of the washcoat. Consequently, on the one hand, the flowability of the washcoat suspension is to be improved and, on the other hand, the application of the washcoat is to take place as uniformly as possible. However, even this method no longer makes it possible to remove completely the excess of the washcoat suspension which is used,

The object, therefore, was to provide a method for the coating of molded articles, in particular for the coating of the internal surfaces of such molded articles having open and/or complex structures, which have internal voids, that is to say, for example, ducts or pore structures, which are connected to one another in regions and pass essentially through the molded article, said method solving the abovementioned problems.

The object was, further, to provide a method for emptying such molded articles, in particular having open and/or complex duct or pore structures, of washcoat suspension used in excess, said method solving the abovementioned problems.

In this context, the solution should be distinguished, in particular, by measures which can be carried out in a simple way.

The object was achieved, according to the invention, in that the predominant fraction of excess liquid is removed in a first emptying step by the action of an external force, and, in a second emptying step, the residual fraction of excess liquid remaining in the molded article after the first emptying step is removed by the molded article being brought into contact, on that end face on which the excess has been discharged in the first emptying step, with a support which is porous and/or has ducts, the pore and/or duct diameter of the support being smaller than or equal to the diameter of the internal voids and/or ducts of the molded article.

Should there be in the support a pore distribution which does not have solely pores or ducts, the diameter of which is smaller than the diameter of the pores or ducts of the molded article, it should be ensured, according to the invention, that approximately 70%, preferably 80%, most preferably 90%, of the pores of the support has a smaller diameter than the pores or ducts of the molded articles, in order to achieve largely complete emptying.

In general, of course, in addition to washcoat suspensions, other suspensions, dispersions, slurries and viscous and nonviscous liquids can also be used according to the invention.

The molded article may, in principle, have any desired geometric shape, but it should have two faces essentially parallel to one another, what are known as “end faces”. Cylindrical molded articles are preferably employed.

The molded article used in the method according to the invention is in this case preferably a ceramic or metallic molded article.

The action of the porous support according to the invention in the emptying method according to the invention is in this case not tied to the emptying principle adopted. Basically, the measure according to the invention may be employed in conjunction with all emptying measures known to a person skilled in the art. It may be employed both in conjunction with a blow-out method and a centrifuging method and in various other emptying methods. However, the use of a special suction device, as in DE 3803579 A1, or the application of a vacuum may be dispensed with. The automation of the emptying process is therefore promoted markedly by the method according to the invention.

Preferably, the support according to the invention which is porous or is pierced with ducts is used for removing the excess washcoat suspension from the ducts or pores of the molded article to be coated, together with the application of an air stream directed onto the ducts or pores (blow-out) and/or by the application of centrifugal forces.

The support used according to the invention, which is porous or pierced with ducts, should in this case come to bear completely, as far as possible plane-parallel, with respect to the end face of the molded articles, in order to achieve as complete an emptying as possible. In this case, it is not absolutely necessary that the porous support used according to the invention is in direct contact with the end face of the molded article to be emptied. On the contrary, in the method according to the invention, a flexible porous intermediate layer, in particular a flexible netting, may be used in order to compensate any unevennesses. Complete contact is thus achieved between the outlet side of the molded article and the porous support used according to the invention, such contact leading to optimal results of the method according to the invention even in the case of end faces of molded articles to be emptied and of the porous support which are not completely planar.

For an optimal result of the method according to the invention, it is therefore expedient, by means of suitable measures, to make with a porous support a contact which prevails over the entire end face (outlet face) of the molded article to be emptied of the excess of washcoat suspension and which is therefore continuous.

A feature essential to the invention is, inter alia, the fact that the diameter of the ducts or pores of the porous support used is on average smaller than or equal to the diameter of the internal voids of the molded article to be emptied, in particular those diameters of the ducts or pores which prevail on the end face of the molded article to be emptied. The average pore diameter or the individual pore cross-sectional area, calculated from this, of the porous support should therefore be no larger than the individual duct cross-sectional area or the average pore diameter on the outlet end face of the molded article to be emptied.

The composition of the porous support is in this case not tied to a specific material. It may be constructed from metal, ceramic, plastic or another material which seems suitable to a person skilled in the art. Combinations of various porous materials and/or materials pierced with ducts may also be envisaged.

In order to achieve an optimal action of the porous support, as already explained, direct contact of the corresponding opposite faces of the molded article and of the support must as far as possible be achieved, in particular over the entire area of the molded article to be emptied.

Furthermore, the possibility of the penetration of the support by the coating suspension, dispersion, slurry or solution must be ensured: the diameter of the smallest pore of the support should be no smaller than the diameter of the largest particle of the coating suspension, dispersion or slurry. Otherwise, these can no longer flow out through the pores of the support, and a blockage of the porous support occurs. This requirement restricts the pore diameter of the porous support to a minimum pore diameter to be selected appropriately as a function, for example, of the washcoat suspension.

In a preferred embodiment of the method according to the invention, a second molded article, preferably of the same type as the molded article to be emptied, or even a second molded article with the same or a smaller duct diameter or pore diameter with respect to the duct diameter or pore diameter of the molded article to be emptied is used as the support according to the invention which is porous or is pierced with ducts. In this case, the length of such a second molded article may be markedly shorter than that of the molded article to be emptied. The length or height of the porous support used according to the invention or of the molded article used for emptying should, however, be at least such that the capillary force of the support or molded article, resulting from the cross section or the diameter and pore length or duct length, is capable of overcoming the capillary forces which act in the carrier or pore ducts of the molded articles to be emptied and which prevent the excess washcoat suspension from flowing out.

If the molded article to be emptied is a metallic molded article, then the molded article used according to the invention for emptying is preferably likewise of a metallic nature and in the case of a honeycomb has plane-parallel ducts. Of course, if appropriate, a ceramic molded article may also be used instead of a metallic molded article.

In a particularly preferred embodiment of the method according to the invention, for emptying a metallic or ceramic honeycomb, a honeycomb of the same type is used, the honeycomb body of this honeycomb used for emptying being freed in the upper part of the casing, in order to achieve as plane-parallel a support as possible of the honeycomb used for emptying on the end face of the honeycomb to be emptied.

Further possible embodiments according to the invention of porous supports are open-pored sponges, nets, nonwovens (porous nonwovens) or comparable materials. The direct and complete contact of the porous support with the emptying face of the molded article over the entire area leads to a complete run-out of the excess washcoat in the molded article.

Possible embodiments of the porous support are also combinations of a metallic or ceramic honeycomb with a nonwoven and/or a net and/or a sponge.

One advantage of the method according to the invention is simple technical implementability. Furthermore, by virtue of the method according to the invention, the undesirable bubble formation on the duct or pore outlet side, often to be observed when surfactant-containing coating suspensions are used, is effectively avoided.

In one possible embodiment of the method according to the invention, the molded articles may first be emptied partially by means of another functional principle, in particular by suction, blowing out, centrifuging or simple flowing out.

In a further embodiment, the abovementioned possibilities for partial emptying may also be employed in combination with the emptying method according to the invention, in particular in succession or simultaneously.

The emptying method according to the invention may be employed, in particular, as part of a method for the complete coating of molded articles having internal voids connected to one another in regions and passing essentially through the molded article.

Thus, a further subject of the invention is a method for coating a molded article having internal voids connected to one another in regions and passing essentially through a molded article, in particular a honeycomb body having ducts or pore structures or a porous metal foam, with a washcoat suspension, comprising

A) suction of a washcoat suspension through the internal voids of the molded article to be coated, by the application of a vacuum to the upper end face of the molded article, while washcoat suspension is supplied on the lower end face,

B) partial emptying of the excess washcoat suspension from the internal voids of the molded article to be coated, by the application of excess pressure on the upper end face of the molded article,

C) removal of the washcoat suspension excess, remaining after step B), from the internal voids of the molded article to be coated, with the aid of a porous support which is mounted on that end face of the molded article on which the excess is to be discharged, the average pore diameter of the porous support being smaller than or equal to the average diameter of the ducts of the molded article.

The complete removal of the excess according to step C) may be employed in combination with any method for the emptying of such molded articles which is familiar to a person skilled in the art.

Preferably, the measure according to the invention, according to step C), is used together with the application of centrifugal forces or inertia forces. Centrifugal forces are understood to mean those forces which occur, for example, during the acceleration or braking of the molded articles and which act on them.

A variant of step B) may in this case be that the partial emptying of the molded article takes place solely by the outflow of the excess washcoat suspension caused by the specific gravity of the latter, the remaining emptying then taking place by means of the emptying method according to the invention, using the porous support.

In a preferred embodiment of the coating method according to the invention, steps A) and B) are executed several times in succession before step C) is carried out. In particular, steps A) and B) are in each case conducted three times, in order to ensure that all the ducts or pores of the molded article have been completely filled at least once with washcoat suspension.

Optionally, filling according to step A) and/or the partial emptying step B) may take place by the action of vibrations, in order to increase the flow properties of the washcoat suspension to be sucked in or to be expelled.

In a further particularly preferred embodiment of the coating method according to the invention, steps A) and B) are carried out even in the presence of the porous support, in which case partial emptying B) then takes place with the simultaneous application of the emptying principle according to the invention, according to step C). What was said above also applies correspondingly to dispersions, slurries or solutions for coating the internal voids or ducts or pore structures of a molded article.

A further subject of the invention is a device (piston/cylinder system) which is used for the filling and partial emptying of internal voids of a molded article which are connected to one another in regions and pass essentially through a molded article, by means of which device the coating method according to the invention can be carried out.

The device according to the invention, according to FIG. 2, is explained with reference to a honeycomb body. What has been said, of course, also applies to all other molded articles, such as, for example, ceramic or metal foams. The device comprises a piston cylinder (a) for sucking in and emptying the washcoat suspension or dispersion, slurry or solution, a connecting plate (b) which is firmly connected to the lower end of the piston cylinder and can be connected sealingly to the upper end face of the honeycomb to be coated, a reception plate (c) which can be connected sealingly on its top side to the lower end face of the honeycomb to be coated, optionally one or more vibration units which are fastened to the reception plate (c), a hydraulically movable suspension (f), by means of which the cylinder unit (a), the connecting plate (b) and the reception plate (c) can be jointly moved horizontally (upward and downward movement), a suck-in/ run-out pipe (d) which is mounted on the underside of the reception plate (c), and a storage trough (e) in which the washcoat suspension is presented.

The leaktight connection of the honeycomb to be coated to the connecting plate (b) and the reception plate (c) takes place preferably by the end faces of the honeycombs being pressed onto corresponding sealing devices on the plates (b) and (c).

The connecting plate (b) and reception plate (c) are in each case pierced in the region in which they are to receive the honeycomb to be filled, so that, on the one hand, pressure or vacuum can be built up via the piston cylinder (a) and, on the other hand, the washcoat suspension can be sucked in and expressed through the suck-in/run-out pipe (d).

By means of the coating method according to the invention and the emptying method according to the invention, in particular, monolithic catalysts or catalysts based on metal foam, which are based on a washcoat consisting essentially of TiO₂ or similar metal oxides, such as SiO₂, Al₂O₃, ZrO₂ or mixtures thereof, can be produced.

The catalysts obtainable by the methods according to the invention can be used, in particular, as catalysts in the purification of exhaust gases, in particular those of internal combustion engines.

Possible uses of the catalysts obtainable via the method according to the invention are, in particular, the purification of automobile and diesel exhaust gases Further, the catalysts produced by the method according to the invention may be used as decomposition catalysts for ammonia precursor compounds, as oxidation catalysts, as catalysts for the elimination of nitrogen oxides and as catalysts for the reduction of nitrogen oxides.

The methods according to the invention may be employed, in particular, for the production of catalysts in which washcoat suspensions, consisting of carrier oxides or carrier oxide combinations selected from the group containing TiO₂, Al₂O₃, SiO₂, CeO₂, ZrO₂ or zeolites, are employed. Said carrier oxides or carrier oxide combinations may in this case, in turn, be doped or coated with metal oxides. Also, even directly catalytically active masses or masses leading directly to catalytically active coatings may be used.

Preferably, the active mass contains as additional components one or more metal oxide compounds selected from the group containing the oxides of vanadium, of tungsten or of molybdenum, in particular V₂O₅, WO₃, MoO₃, or noble metal salts, in particular those of palladium, platinum, rhenium or rhodium.

However, the catalytically active components may also be applied only in a subsequent step after the molded article coated and emptied according to the invention has been subjected to thermal treatment.

The washcoat suspensions, dispersions or slurries which can be used in the methods according to the invention may contain water, additives and catalytic active components in addition to inorganic carrier oxides.

The washcoat suspensions used in the methods according to the invention may have added to them inorganic brines or gels, in particular SiO₂, TiO₂, Al₂O₃ brines or gels, for improving the adhesion of the resulting coating, additives, such as organic monomers and polymers, in particular cellulose derivatives or acrylates, as pore formers, and also as adhesion promoters, and/or surfactants as rheological promoters.

In particular, molded articles consisting of materials selected from the group containing cordierite, silicates, zeolites, silicon dioxide, silicon carbide, aluminum oxide and aluminates or mixtures of these substances and also metals or metal alloys are suitable for the molded articles to be emptied and to be coated by the methods according to the invention. Metallic carrier structures are particularly preferred.

Metallic molded articles are preferred, complexly structured metal carriers and metal foams are particularly preferred. However, ceramic honeycombs or ceramic foams may also be used. The metal or ceramic molded articles which can be used according to the invention may in this case be pretreated by means of a thermal or else chemical process in such a way that the adhesion of a layer applied later is improved. By means of the method according to the invention, molded articles having a high to very high cell or pore density can also be emptied.

The catalysts produced in this way may also pass through a drying step and a subsequent calcinating step. The further application of catalytically active compounds, such as, for example, noble metal compounds, is also possible. The catalysts thus produced are employed particularly in gas purification processes, in particular in the purification of automobile exhaust gases. They can, however, also be used in other catalytic processes, such as, for example, in the chemical industry or in energy generation.

In summary, the present invention relates to a method for the coating of catalyst carriers by means of a step of filling a carrier body with a washcoat suspension on the outside [Def. A1], and of a subsequent emptying step for removing the excess washcoat suspension.

At least at the conclusion of the emptying step, the filled or still partly filled molded article is brought with its outlet end face into contact with a porous support, with the proviso that the average pore diameter or the individual pore cross-sectional area, calculated from this, of the support is no larger than the individual cross-sectional area of a representative duct or pore duct on the outlet end face of the catalyst carrier. The catalyst carriers coated in this way may be used as carrier catalysts, in particular for the purification of automobile exhaust gases.

### EXPLANATION OF THE FIGURES

FIG. 1 is an illustration of the air stream (arrows) for blowing out the excess washcoat suspension in open structures. The illustration shows two adjacent ducts connected to one another by means of perforations, as a detail of a honey-comb body. The air stream follows the path of least pressure loss in the perforated ducts, after which, in such a case, a remaining emptying of all the ducts becomes impossible by blowing out alone. The excess washcoat suspension is held in the ducts by the capillary forces.

FIG. 2 is a diagrammatic illustration of a piston/cylinder system according to the invention.

FIG. 3 shows a honeycomb immediately after extraction from the piston/cylinder system according to comparative example 3. The ducts are still filled completely with excess washcoat suspension on the side of the outlet face (lower end face).

FIG. 4 shows a honeycomb according to comparative example 3 after the action of an air stream (blowing out).

FIG. 5a shows a view of a honeycomb (top) to be coated and subsequently to be freed of excess washcoat, with a mounted second auxiliary honeycomb or supporting honeycomb (bottom), for purposes of complete emptying according to example 4.

FIG. 5b shows a view of a detail of the attachable auxiliary or supporting honeycomb according to example 4, in which it can be seen that a small part of the honeycomb casing has been removed by being milled off, to ensure that the lower outlet face of the honeycomb to be emptied (not shown) comes into bearing contact with the upper end face of the auxiliary honeycomb completely.

FIG. 6 is a view of the lower outlet face of a coated honeycomb freed completely of excess washcoat according to example 4.

FIG. 7 is a view of the lower outlet face of a honey-comb treated solely by centrifuging according to comparative example 5, without the use of an auxiliary honeycomb.

FIG. 8 is a view of the lower outlet face of a honey-comb treated by centrifuging according to example 6 in the presence of an auxiliary honeycomb.

FIG. 9 is a view of the lower outlet face of a honeycomb treated according to example 7 (blowing out), where ducts still partially unemptied can be seen because the auxiliary honeycomb is not in complete bearing contact over the entire area of the outlet face of the honeycomb to be freed of excess washcoat.

FIG. 10 is a view of the lower outlet face of a honeycomb treated according to example 8 (blowing out), where the unevennesses on the upper end face of the auxiliary honeycomb, which prevent the auxiliary honeycomb from coming to lie completely, plane-parallel, over the entire outlet face, are compensated by the introduction of a flexible netting between the outlet face of the honeycomb to be freed of excess washcoat and the upper end face of the auxiliary honeycomb.

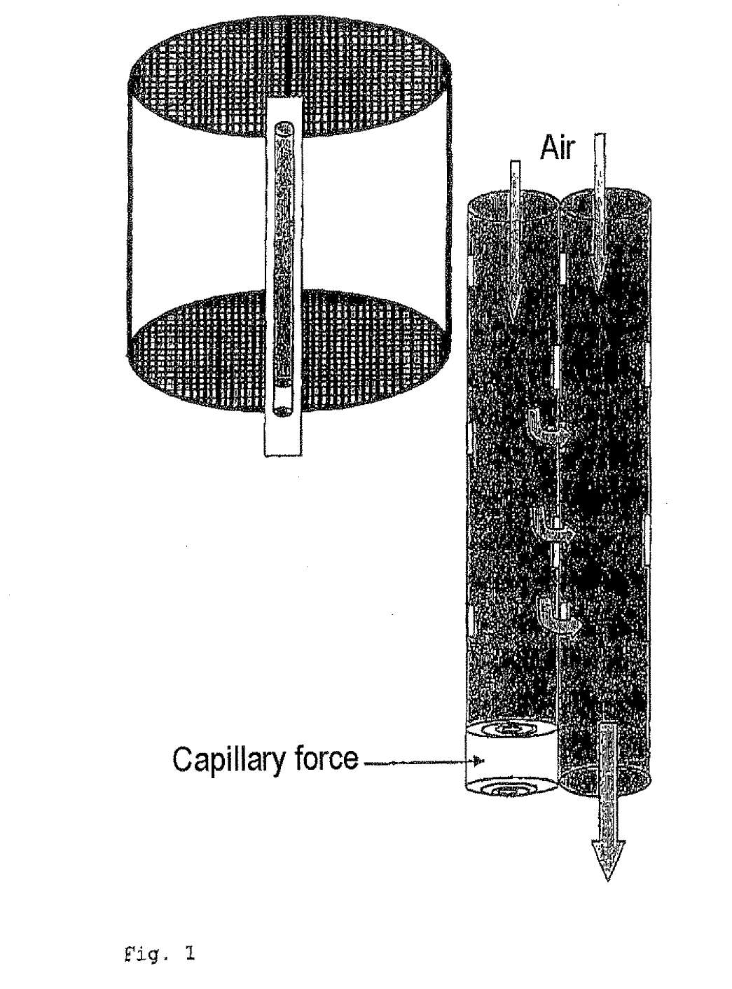

The following examples are intended to explain the invention in more detail and are in no case to be understood as a restriction.

### EXAMPLE 1

### Production of a Typical Washcoat Suspension

100 g of TiO₂ with a BET surface of 80 m²/g are agitated in 80 g of water, subsequently 40 g of an aqueous SiO₂ brine (SiO₂ content: 40%) are added as a binder, and the suspension is thereafter homogenized in a colloid gear mill. The resulting washcoat suspension has a viscosity of about 4100 mpa*s.

### EXAMPLE 2

### Filling and Partially Emptying of Honeycombs

### 2.1 Description of the Filling and Partially Emptying System

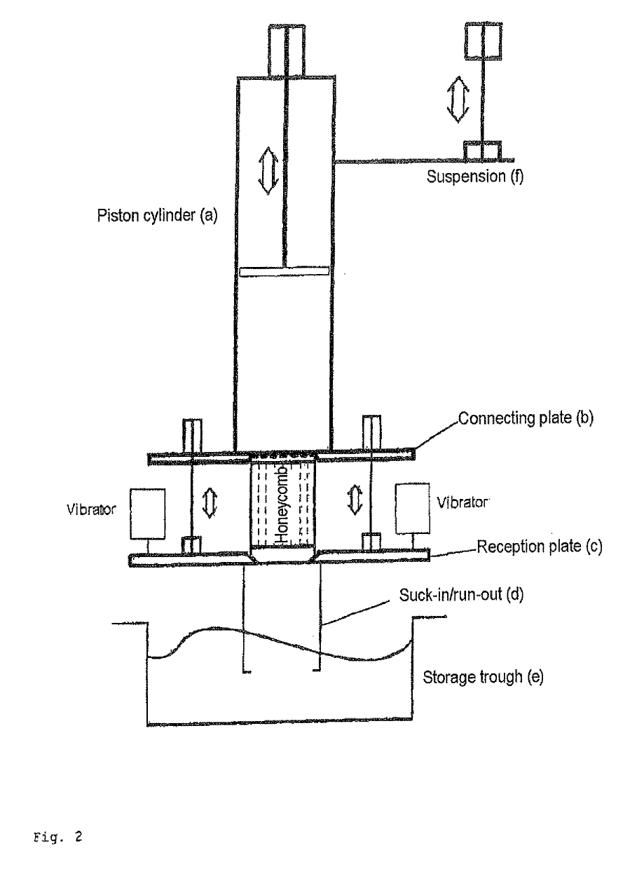

The filling and also partially emptying of the honeycomb bodies were carried out with the aid of a piston/cylinder system according to FIG. 2.

The system consists essentially of a piston cylinder (a) for sucking in and emptying the washcoat suspension, and of a connecting plate (b) which is firmly connected to the suction cylinder at the lower end of the suck-in cylinder and which is dimensioned in its underside such that exactly the upper end face of the honeycomb can be connected sealingly to the suction cylinder by a reception plate (c) being pressed on. One or more vibration units may optionally be fastened to the reception plate (c). This holding device (plates (c) and (b)) can be moved up and down jointly with the cylinder unit (a) hydraulically via the suspension (f).

A suck-in/run-out pipe (d) is flanged to the underside of the reception plate (c), the top side of which is configured such that the lower end face of the honeycomb can be received. The test installation is completed by a storage trough (e) in which the washcoat suspension is introduced.

### 2.2 General Conduct of the Filling and Partially Emptying of a Honeycomb Body

The washcoat suspension from example 1 is presented in the storage trough (e), specifically at least to an extent such that the suck-in pipe (d) always dips completely into the washcoat suspension during the subsequent filling operation. The honeycomb is then inserted sealingly into the holding device, comprising the plates (b) and (c), by the reception plate (c) together with the honeycomb being pressed hydraulically onto the connecting plate (b), and the piston/cylinder unit (a) is moved downward, jointly with the holding device, comprising the plates (b) and (c), hydraulically via the suspension (f), to an extent such that the immersion pipe (d) dips into the washcoat suspension. The cylinder piston (a) is subsequently moved upward (likewise hydraulically), with the result that the washcoat suspension is sucked into the honeycomb via the suction pipe (d). The piston stroke is in this case set such that the washcoat suspension is sucked in at least to an extent such that the upper end face of the honeycomb is completely covered. By the piston (a) being lowered rapidly, a large part of the excess washcoat suspension is expelled into the storage trough (e) again. This operation is repeated at least twice, thus ensuring that all the ducts have been fully filled (flooded) at least once.

For the better filling/emptying of the honeycomb, during the entire operation the vibrator fastened to the reception plate (c) is operated (compressed air vibrator: the company Netter, NFP 18s, nominal frequency at 6 bar=7700 min″¹, centrifugal force at 6 bar 128 N), in order to improve the flow property of the washcoat suspension by a vibrational frequency being applied.

After three pumping-in and expressing operations, the piston is held at the bottom for one minute after the last expressing operation. The cylinder piston (a), together with the holding device, comprising the plates (b) and (c), is thereafter moved upward again pneumatically via the suspension (f), the run-out pipe (d) no longer finally dipping into the washcoat suspension. The honeycomb can be extracted for further processing (remaining emptying) after a corresponding relief of pressure (depressurization of the hydraulics from the holding device).

### COMPARATIVE EXAMPLE 3

### Coating of a Metallic Carrier Body (Honeycomb) Having a Mixer Function, Using a Vibration Unit and Remaining Emptying by Means of an Air Stream

A complexly structured metal honeycomb with a mixer function (the company Emitec, type: MI) with a length of 7.5 cm, a diameter of 7 cm and a cell density of 200 cpsi is pretreated at 750° C. thermally for 4 hours in a calcinating furnace under an air atmosphere. The honeycomb cooled to room temperature is then filled by means of the procedure described under example 2.2. The test honeycomb was thereafter extracted. FIG. 3 depicts the lower end face of the test honeycomb. It can be seen clearly that the entire lower end face of the honeycomb is still covered with washcoat suspension.

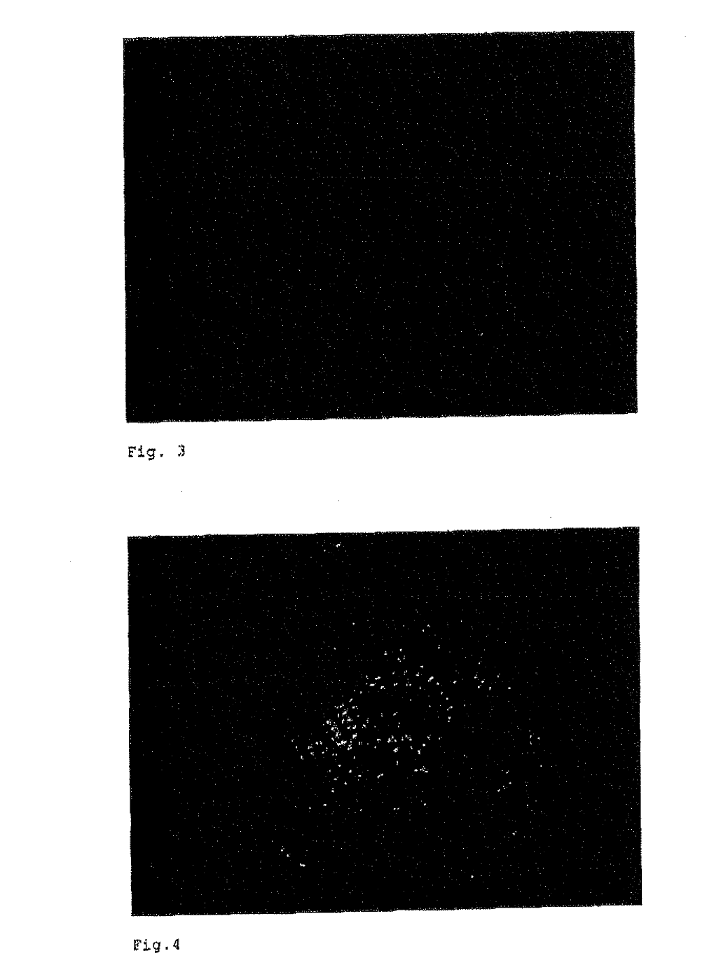

Immediately thereafter, an air stream (approximately 200 m³/h) for remaining emptying is blown (blow-but) through the honeycomb for a duration of 1 minute. As can be seen in FIG. 4, however, this measurer too, does not lead to a satisfactory result. Only a small fraction of the ducts is emptied completely by the air stream.

### EXAMPLE 4

### Coating of a Metallic Carrier Body Having a Mixer Function, Using a Vibration Unit and a Porous Base in the Form of a Second Carrier Honeycomb

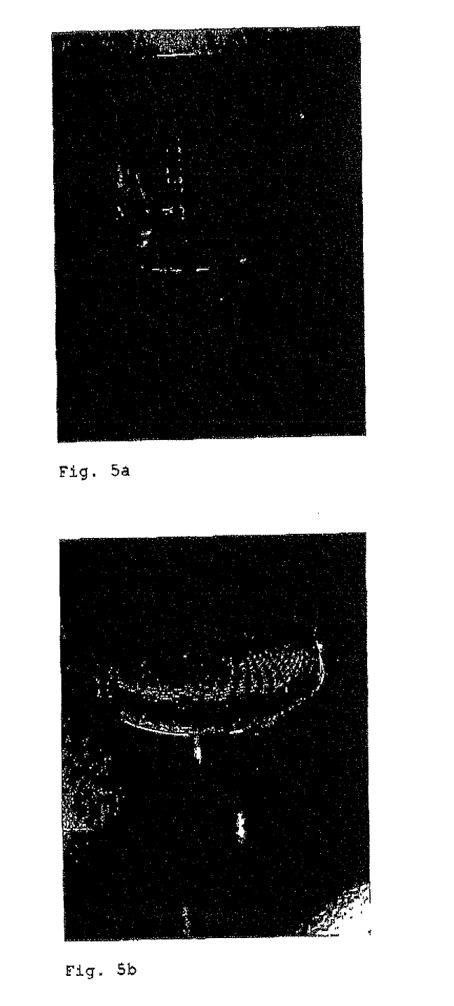

The test described in comparative example 3 was repeated, with the difference that a second honeycomb is attached as a porous base on the underside of the honeycomb to be emptied (cf. FIG. 5a), and blowing out is dispensed with. So that direct surface contact between the honeycomb to be emptied and the attached auxiliary honeycomb is made, a small part of the honeycomb casing of the auxiliary honeycomb is milled off (cf. FIG. 5b). The same filling and emptying procedure was then carried out with this combination (FIG. 5a).

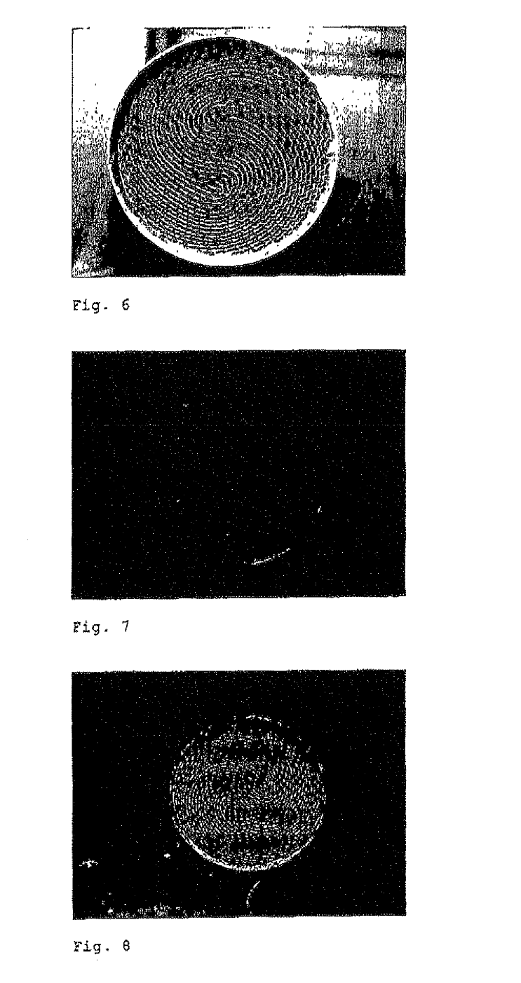

The result of the emptying operation can be seen in FIG. 6. It can be seen clearly that, using the second auxiliary honeycomb and the complete contact of the supporting surfaces of the two honeycombs, all the ducts of the honeycomb to be emptied could be freed completely of excess washcoat.

### COMPARATIVE EXAMPLE 5

### Coating of a Metallic Carrier Body Having a Mixer Function, Using a Vibration Unit and a Subsequent Centrifuging Step for Remaining Emptying

The test described in comparative example 3 is repeated, with the exception that, for remaining emptying, the test honeycomb was introduced into a centrifuge (d=600 mm) and centrifuged there at a rotational speed of 140 rpm for a duration of 0.5 minutes.

The result can be seen in FIG. 7: although, after centrifuging, a large part of the remaining washcoat suspension was removed from the metal honeycomb, the outlet face was nevertheless still almost completely closed by excess washcoat suspension. A use of such a honeycomb without further retreatment for the remaining removal of the washcoat would not be possible.

### EXAMPLE 6

### Coating of a Metallic Carrier Body Having a Mixer Function, Using a Vibration Unit and a Subsequent Centrifuging Step, Using a Porous Support

The test described in comparative example 5 is repeated, with the difference that, before the centrifuging step, a second auxiliary honeycomb is attached, in which part of the upper honeycomb casing is removed in order to ensure direct surface contact.

As can be seen from FIG. 8, the entire outlet face of the honeycomb is then free of washcoat suspension.

### EXAMPLE 7

### Coating of a Metallic Carrier Body Having a Mixer Function, Using a Vibration Unit and a Porous Base in the Form of a Second Carrier Honeycomb, but in Which the End Faces Have Only Partially Direct Contact With One Another

The test described in example 4 is repeated, with the difference that the mutually confronting faces of the honeycomb to be emptied and of the auxiliary honeycomb (supporting honeycomb) had no complete contact extending over the entire outlet face. This is brought about in that a honeycomb with a not completely planar end face is deliberately used as a supporting honeycomb.

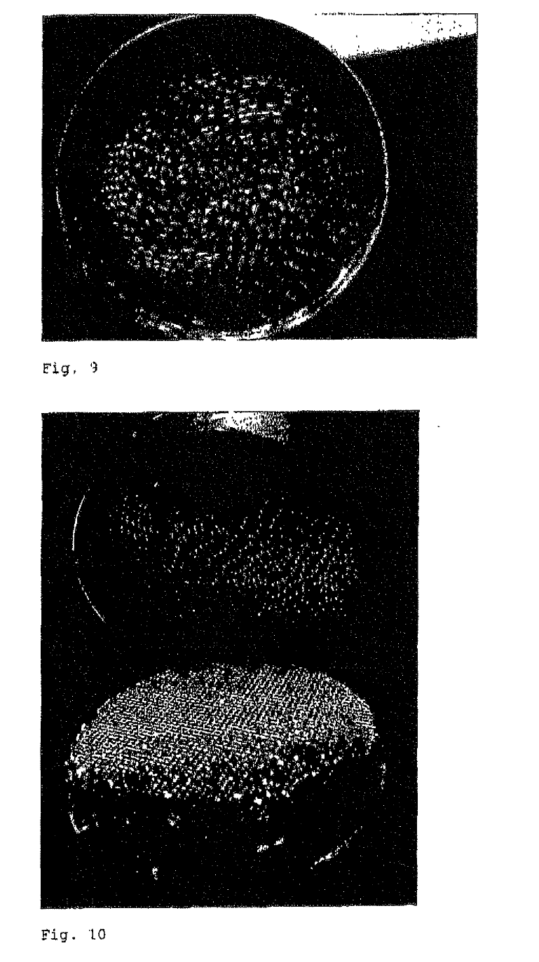

The outlet side of the test honeycomb after the coating test can be seen in FIG. 9. Even a slight fault in surface contact leads to incomplete emptying and therefore a partial blockage of the ducts.

### EXAMPLE 8

### Coating of a Metallic Carrier Body Having a Mixer Function, Using a Vibration Unit and a Combination of a Honeycomb and Netting as a Porous Base

The test described in example 7 is repeated, with the difference that a layer of a flexible netting (thread thickness: 0.3 mm, mesh width: 1.2 mm*1.2 mm) is additional laid between the mutually opposite faces which are not completely plane-parallel. In contrast to the test according to example 7, after the coating process all the ducts were then free of washcoat suspension in the honeycomb to be coated and to be emptied (and to be freed of excess washcoat) (FIG. 10).

1. A method for removing an excess of liquid from a molded article having two mutually opposite planar end faces, which has internal voids and/or ducts to be coated with the liquid, after the introduction of the liquid into the internal voids and/or ducts the predominant fraction of excess liquid being removed in a first emptying step, the residual fraction of excess liquid remaining in the molded article after the first empting step being removed by the molded article being brought into contact, on that end face on which the excess has been discharged, with a support which is porous and/or has ducts, the pore and/or duct diameter of the support being smaller than or equal to the diameter of the internal voids and/or ducts of the molded article.

2. A method as claimed in claim 1, the liquid being a solution, suspension, dispersion or slurry.

3. The method as claimed in claim 2, the suspension being a washcoat suspension, and the introduction of the washcoat suspension taking place by the washcoat suspension being sucked in through the internal voids and/or ducts of the molded article to be coated, by the application of a vacuum on the upper end face of the molded article, while washcoat suspension is supplied on the lowed end face.

4. The method as claimed in claim 3, the first step of emptying the excess washcoat suspension being carried out by the application of excess pressure on the upper end face of the molded article.

5. The method as claimed in claim 1, characterized in that the removal of the remaining excess is carried out in the second emptying step in conjunction with the use of an air stream directed onto the internal voids and/or ducts of the molded article and/or by the application of centrifugal forces and/or by the sole outflow of the excess washcoat suspension, caused by the specific gravity of the latter.

6. The method as claimed in claim 1, characterized in that the support which is porous and/or has ducts is selected from the group containing open-pored sponges, nets, nonwovens and still untreated molded articles of the same type as the molded article to be emptied.

7. The method as claimed in claim 6, characterized in that the molded article to be coated and to be emptied consists of a material which is selected from the group containing cordierite, silicates, zeolites, silicon dioxide, silicon carbide, aluminum oxide and aluminates or mixtures of these substances and also metals or metal alloys.

8. The method as claimed in claim 1, characterized in that the molded article to be coated and to be emptied has open and/or complex structures.

9. The method as claimed in claim 1, characterized in that the molded articles to be coated and to be emptied have perforated ducts or pore structures.

10. The use of a molded article as claimed in claim 1, obtainable as a catalyst.

11. A device for carrying out the method as claimed in claim 1, comprising a piston cylinder (a) for sucking in and empting a washcoat suspension, a connecting plate (b) which is firmly connected to the lower end of the piston cylinder and can be connected sealingly to the upper end face of a molded article to be coated, a reception plate (c) which can be connected sealingly on its top side to the lower end face of the molded article to be coated, optionally one or more vibration units which are fastened to the reception plate (c), a hydraulically movable suspension (f), by means of which the cylinder unit (a), the connecting plate (b) and the reception plate (c) can be jointly moved horizontally upward and downward, a suck-in/run-out pipe (d) which is mounted on the underside of the reception plate (c), and a storage trough (e) in which the washcoat suspension is presented.
